(19) United States
(12) Patent Application Publication
(10) Pub. No.: US 2007/0181550 A1
(43) Pub. Date: Aug. 9, 2007

(54) A-TIG welding of copper alloys for generator components

(75) Inventors: David S. Segletes, York, SC (US); Dennis R. Amos, York, SC (US)

Correspondence Address: Siemens Corporation;Intellectual Property Department, 170 Wood Avenue South, Iselin, NJ, 08830, US

(73) Assignee: Siemens Power Generation, Inc.

(21) Appl. No.: 11/703,472

(22) Filed: Feb. 7, 2007

Related U.S. Application Data
(60) Provisional application No. 60/771,562, filed on Feb. 8, 2006.

(51) Int. Cl. B23K 9/23

(52) U.S. Cl. 219/137 WM

(57) ABSTRACT

The present invention provides for the welding of copper using activated TIG welding (8). In particular, the copper coils (6) of electrical generators (2) are welded using the present invention.

This application claims priority to U.S. provisional application 60/771,562, entitled “A-TIG Welding of Copper Alloys for Generator Components,” filed Feb. 8, 2006, which is incorporated herein by reference.

### FIELD OF THE INVENTION

The field of the invention relates to the welding of copper components, and in particular copper generator components, with a tungsten inert gas process with the addition of an activating flux.

### BACKGROUND

In tungsten inert gas (TIG) welding an arc is established and maintained between a tungsten electrode (non-consumable) and the metal to be welded. An inert gas shields the arc from the ambient to prevent oxidation. A filler material is optional. TIG welding joins metals by heating them with a tungsten electrode which should not become part of the completed weld. Filler metal is sometimes used and argon inert gas or inert gas mixtures are used for shielding, and one of the hoses connected to the torch is the shielding gas hose. When the gas flow has been activated, the shielding gas flows up through this hose and out the end of the torch, thereby enveloping the electrode and the molten portion of the work piece in a protective blanket of gas.

A method of using TIG welding can be found in US Patent Application No. 20050258144. Carbon steels, low alloy steels, stainless steels, most aluminum alloys, and zinc based copper alloys can be welded using the TIG process. Pure, and mostly pure copper, however, is still not easily welded by the TIG method. This is in part due to copper's high thermal conductivity. The heat of the arc is conducted away by the copper.

As a result, the large copper components in electrical generators are still joined by brazing. Brazing, however, is not as strong as welding and produces excessive heat, which can damage other generator components, such as electrical insulation materials. The brazing materials are also expensive, and with 400-500 braze joints in a typical electrical generator, this becomes a significant cost.

What is needed is a method and apparatus that can form stronger joints, with less excess heat. Other difficulties with the prior art also exist, some of which will be apparent upon further reading.

### SUMMARY OF THE INVENTION

With the foregoing in mind, methods and apparatuses consistent with the present invention, which inter alia facilitates the welding of copper include using activated flux in the TIG welding process. The welding of copper has heretofore been limited since copper, especially pure and lesser alloyed copper alloys, are very difficult to weld. Certain techniques such as increased preheat to overcome these welding difficulties only exacerbates the heating problem with insulated materials. Therefore, the brazing of copper, such as copper coils in electrical generators, has been required to join pieces. The present invention uses activated TIG welding which can actually effect a strong weld between coppers units. The weld not only increases the strength and life of the machine, but also the electrical conductivity through the joint. This also allows creation of joints near typically-sensitive insulated components without damage to the components which would be caused by brazing. In addition this allows for reduced component size and joints in locations not appropriate for brazing.

These and other objects, features, and advantages in accordance with the present invention are provided by providing for a method of welding copper that comprises placing an activated flux on the desired site of a copper weld and welding the copper using TIG. The activated flux comprises 20-50% by weight of at least one of SiO2, TiO2, Cr2O3 and a halide. In particular embodiments the welding of copper is on copper coils in an electrical generator, and targets on the copper coils include end turns, consolidation joints and series connections between top and bottom strands. The copper being welded is pure copper or a high copper alloy and does not require preheat.

In another embodiment of the present invention, a copper weld is produced by applying an activated flux on the weld site, then welding the copper with a TIG welding process. The depth of the weld is at least 5 mm, and the copper is not preheated prior to welding.

In particular embodiments, the copper weld has a length of the 3.2-4.0 cm. The activated flux comprises 20-50% by weight of at least one of SiO2, TiO2, Cr2O3 and a halide, and the copper is not beveled, nor is a filler material used in the welding.

In another embodiment the present invention provides for a method of welding copper coils that comprises applying an activated flux to abutted ends of copper coils, the abutted copper coils are between 0.0-2.0 mm apart, then welding the copper coils at approximately 220 amps, and 9-11 volts, and a speed of approximately 7.5-9.0 cm/min, the welding is preformed without preheating the copper coils and without a filler material. The copper coils are at least 95% copper, and up to 99% copper, are unbeveled, and no filler material is used in the welding.

In further particular embodiments, the length of the weld is approximately 3.2-4.0 cm (1.25-1.6 inches), and the activated flux comprises 40-50% by weight of at least one of SiO2, TiO2, Cr2O3.

Other embodiments of the present invention also exist, which will be apparent upon further reading of the detailed description.

### BRIEF DESCRIPTION OF THE FIGURES

The invention is explained in more detail by way of example with reference to the following drawings:

FIG. 1 illustrates where in a generator's rotor winding joints are typically made.

FIG. 2 illustrates a close-up view of rotor windings.

FIG. 3 illustrates a welder welding two copper ends.

### DETAILED DESCRIPTION OF THE INVENTION

The present invention provides for a system and method for joining pure and mostly pure copper using activated tungsten inert gas (TIG) welding. In the prior art, welding of copper joints was not applicable for larger pieces of copper, so the costly brazing techniques were used. These brazes produce weaker joints, and brazing in general produce excess heat that can damage surrounding parts. For large electrical generators, this meant that many brazes had to be applied to the large copper coils, damaging surrounding insulation.

Activated TIG uses a pre-applied fluxing agent that alters the characteristics of the welding arc. A thin coating of the flux applied to the surface of the material constricts the welding arc which increases the current density at the anode root and the arc force. The constricted arc significantly increases weld pool penetration over conventional TIG welding and produces a deep, narrower weld. This produces greater depth of penetration, higher welding speed and a reduction in the sensitivity to cast material variation.

The composition of an activated flux comprises SiO2, TiO2, Cr2O3 and/or halide. The mass fraction of the activated flux, i.e. the percentage by weight of activated materials in the flux, is from about 20-50%. The prior art of brazing has been able to join copper to a depth of about 3.2 mm, while the present invention will penetrate the copper to a depth of about 6 mm (0.25″) or greater.

The length of the welds will have a typical range of about 3.2-4.0 cm (1.25-1.6 inches). In preferred conditions the welding parameters will be approximately 220 amps, with a voltage of between 9-11 volts, and a travel speed of about 7.5-9.0 cm/min. (3-3.5″/min.). The gap between the joints should be of a range between 0.0-2.0 mm. Unlike with typical welds that require beveling of the joints to make a clean weld, the present invention does not require beveling, and unlike conventional welds filler metal is not used. Not needing filler materials makes for a cleaner joint, and saves on expensive filler material.

Some types of activated fluxes are commercially available from TWI, EWI, Miller Electric, the Paton Institute and Liburdi Engineering. Fluxes can be produced in the form of either an aerosol spray or as a paste, which is a powdered flux mixed with a solvent and is applied to a surface with a brush. The spray is a preferable method of dispensing the flux since it offers greater expediency.

Unlike conventional welding, preheating of the copper is not necessary for activated TIG welding. This is particularly suited for assemblies such as generators where the preheating can damage the surrounding electrical insulation.

The activated TIG can narrowly focus the heat of the weld directly through the copper butt joints, which causes minimal impact to the surrounding parts, and heats the copper faster than the heat can be conducted away. This results in better joints that are not only stronger but also have less electrical resistance than the brazed joints.

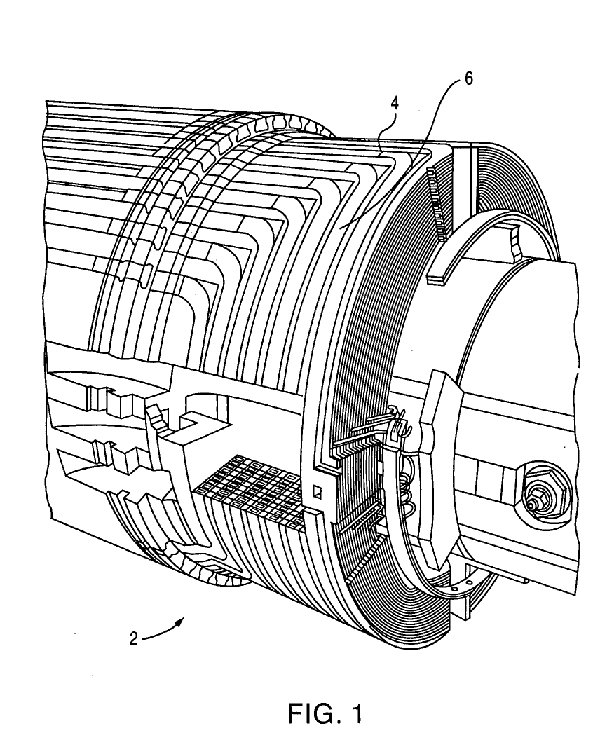

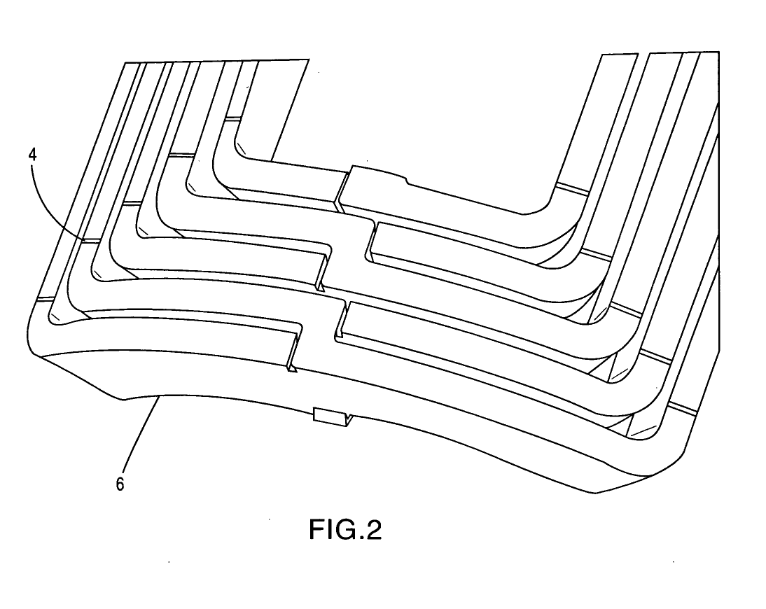

FIG. 1 illustrates a typical electrical generator 2 where the present invention can be applied. Also illustrated are where typical braze locations 4 are on the copper coils 6. Other targets include the end turns, consolidation joints and series connections between the top and bottom strands. FIG. 2 shows a different view of a close-up of end windings 6 and where the typical braze locations 4 are.

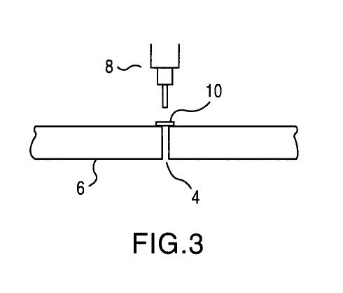

Referring to FIG. 3, two copper coil ends 6 are being brazed 4 by a welder 8 using and activated flux 10 which may be either a paste or a spray. The depth of this weld would be approximately 6 mm (0.250 inches), which creates a significantly greater connection than the prior art.

Copper, like many metals, is usually combined with at least some amount of other materials. The present invention is applicable to welding both pure copper and high copper alloys. Pure copper is considered to be over 99% copper, while high copper alloys are at least 95% copper.

In one embodiment the present invention provides for a method of welding copper that comprises placing an activated flux on the desired site of a copper weld, and welding the copper using TIG. The activated flux comprises 20-50% by weight of at least one of SiO2, TiO2, Cr2O3 and a halide, the remainder being a solvent carrier. In particular embodiments the welding of copper is on copper coils in an electrical generator, and targets on the copper coils include end turns, consolidation joints and series connections between top and bottom strands. The copper being welded is pure copper or a high copper alloy and does not require preheat.

In another embodiment of the present invention, a copper weld is produced by applying an activated flux on the weld site. Then welding the copper with a TIG welding process. The depth of the weld is at least 5 mm, and the copper is not preheated prior to welding. In particular embodiments, the copper weld has a length of the weld is 3.2-4.0 cm. The activated flux comprises 20-50% by weight of at least one of SiO2, TiO2, Cr2O3 and a halide, and the copper is not beveled, nor is a filler material used in the welding.

In another embodiment the present invention provides for a method of welding copper coils that comprises applying an activated flux to abutted ends of copper coils, wherein the abutted copper coils are between 0.0-2.0 mm apart. Then welding the copper coils at approximately 220 amps, and 9-11 volts, and a speed of approximately 7.5-9.0 cm/min, the welding is preformed without preheating the copper coils and without a filler material. The copper coils are at least 95% copper, and up to 99% copper, are unbeveled, and no filler material is used in the welding.

In further particular embodiments, the length of the weld is approximately 3.2-4.0 cm (1.25-1.6 inches), and the activated flux comprises 40-50% by weight of at least one of SiO2, TiO2, Cr2O3.

While specific embodiments of the invention have been described in detail, it will be appreciated by those skilled in the art that various modifications and alternatives to those details could be developed in light of the overall teachings of the disclosure. Accordingly, the particular arrangements disclosed are meant to be illustrative only and not limiting as to the scope of the inventions which, is to be given the full breadth of the claims appended and any and all equivalents thereof.

What is claimed is:

1. A method of welding unbeveled copper comprising:
placing an activated flux on the desired site of a copper weld; and
welding the copper using TIG without a filler material;
wherein the activated flux comprises 20-50% by weight of at least one of SiO2, TiO2, Cr2O3 and a halide.

2. The method of claim 1, wherein the welding of copper is on copper coils in an electrical generator.

3. The method of claim 2, wherein targets on said copper coils are at least one of end turns, consolidation joints and series connections between top and bottom strands.

4. The method of claim 1, wherein the copper is at least one of pure copper and a high copper alloy.

5. A copper weld produced by:
applying an activated flux on the weld site; and
welding the copper with a TIG welding process;
wherein the depth of the weld is at least 5 mm;
whereby the copper is not preheated prior to welding.

6. The copper weld of claim 5, wherein the length of the weld is 3.2-4.0 cm.

7. The copper weld of claim 5, wherein said activated flux comprises 20-50% by weight of at least one of SiO2, TiO2, Cr2O3 and a halide

8. The copper weld of claim 5, wherein said copper is not beveled.

9. The copper weld of claim 5, wherein filler material is not used in the welding.

10. A method of welding copper coils comprising:
applying an activated flux to abutted ends of copper coils, wherein said abutted copper coils are between 0.0-2.0 mm apart; and
welding said copper coils at approximately 220 amps, and 9-11 volts, and a speed of approximately 7.5-9.0 cm/min, wherein the welding is preformed without preheating said copper coils and without a filler material;
wherein said copper coils are unbeveled;
wherein no filler material is used in the welding;
wherein said copper coils are at least 95% copper.

11. The method of claim 10, wherein said copper coils are about 99% copper.

12. The method of claim 10, wherein the length of the weld is approximately 3.2-4.0 cm (1.25-1.6 inches).

13. The method of claim 10, wherein said activated flux comprises 40-50% by weight of at least one of SiO2, TiO2, Cr2O3.

14. The method of claim 10, wherein said copper coils are being assembled within a generator.
